(19) United States
(12) Patent Application Publication
(10) Pub. No.: US 2023/0024929 A1
(43) Pub. Date: Jan. 26, 2023

(54) STEERING DEVICE

(71) Applicant: SandShark, Inc., Plymouth, IN (US)

(72) Inventors: Jeffrey Alan STEININGER, St. Marys, OH (US); Duane MATTIX, Plymouth, IN (US)

(21) Appl. No.: 17/385,394

(22) Filed: Jul. 26, 2021

(51) Int. Cl. B60S 9/04

(52) U.S. Cl. CPC B60S 9/04

(57) ABSTRACT

A trailer including a frame configured to receive an item or items to be stored thereon or therein and at least one trailer wheel coupled to the frame. The trailer further includes a trailer jack coupled to the frame and including a foot at an end thereof. The trailer jack includes a handle coupled thereto, wherein the handle is pivotable between a retracted position wherein the handle is oriented generally vertically when the trailer jack is in the operating position, and an engaged position wherein the handle is oriented at an angle relative to a vertical axis when the trailer jack is in the operating position.

This application is directed to a steering device, and more particularly, to a steering device for a trailer and/or trailer jack.

### BACKGROUND

Trailers are often used to store and transport various cargo or freight, and/or can be specially configured to transport boats, watercraft, vehicles, snowmobiles, etc. The trailer may include a trailer jack (which can be part of the original trailer or an aftermarket add-on) that includes or takes the form of a vertically-oriented shaft member with a wheel at the bottom of the shaft to support at least part of the weight of the trailer when the trailer is not hitched to a vehicle.

The wheel of trailer jack may be pivotable about a vertical axis to allow the wheel to be aligned in the desired direction. However, in many existing trailers, the trailer jack wheel may be difficult to pivot, particularly when the trailer jack wheel bears at least part of the weight of the trailer. In addition, the trailer jack wheel can in some cases be positioned under the trailer and thus be difficult to access. In some cases, the operator may use their foot and kick the trailer jack wheel to attempt to pivot the wheel in the desired direction. However this method is not particularly effective and can cause harm to the trailer jack and/or operator's foot, and/or in certain cases may cause the operator to lose their balance.

### SUMMARY

In one embodiment, the application discloses a steering device that enables a trailer jack and/or the associated trailer jack wheel to be relatively easily accessed and pivoted to the desired orientation. More particularly, in one embodiment the invention is a trailer including a frame configured to receive an item or items to be stored thereon or therein and at least one trailer wheel coupled to the frame. The trailer further includes a trailer jack coupled to the frame and including a foot at an end thereof. The trailer jack includes a handle coupled thereto, wherein the handle is pivotable between a retracted position wherein the handle is oriented generally vertically when the trailer jack is in the operating position, and an engaged position wherein the handle is oriented at an angle relative to a vertical axis when the trailer jack is in the operating position.

### BRIEF DESCRIPTION OF DRAWINGS

FIG. 1 is a front perspective view of a trailer incorporating a trailer jack, which in turn incorporates a steering device, with the trailer jack in an operating position and the handle in an engaged position;

FIG. 2 is a detail view of the trailer jack of FIG. 1;

FIG. 3 is a detail view of the trailer jack of FIG. 1, with the trailer jack wheel pivoted to a different position;

FIG. 4 shows the trailer jack of FIG. 2 in a retracted position, and with the handle in a retracted position;

FIG. 5 is a front perspective view of part the trailer jack of FIG. 2, with the handle in a retracted position;

FIG. 6 shows the part of the trailer jack of FIG. 5 shown for reference purposes, with the steering device in an exploded configuration; and

FIG. 7 is a perspective view of the steering device of FIG. 6 shown in an assembled configuration.

### DETAILED DESCRIPTION

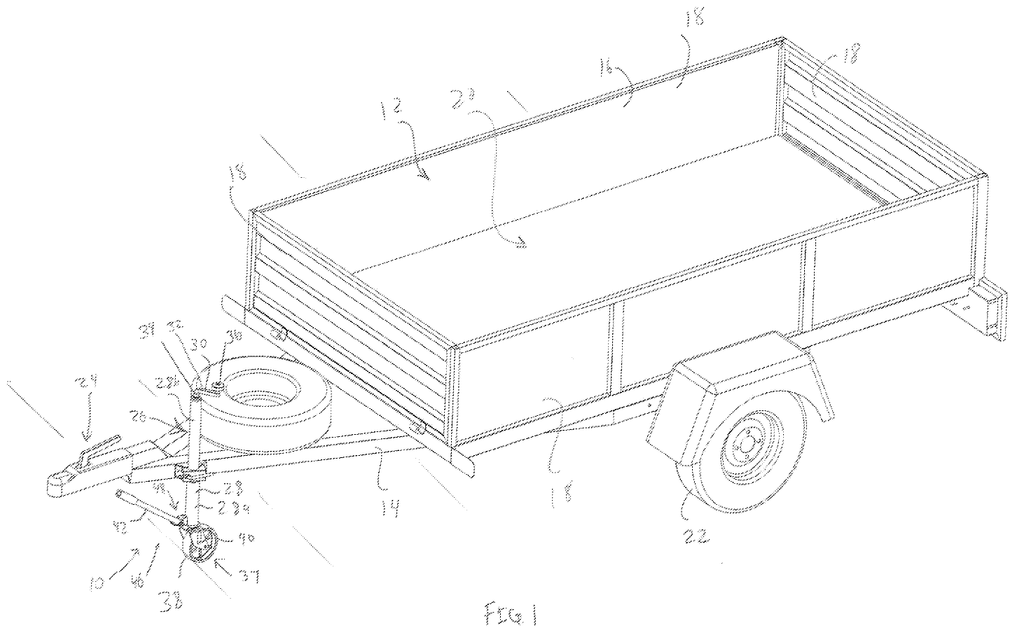

With reference to FIG. 1, the steering device/trailer steering device 10 disclosed herein can be used in conjunction with a trailer 12 including a frame 14 which includes, or has coupled thereto, a storage bed 16. The storage bed 16 is configured to receive an item or items to be stored thereon or therein, and in the illustrated embodiment takes the form of a set of vertically-oriented walls 18 defining an enclosed space 20. However, it should be understood that the frame 14/storage bed 16 can take any of a wide variety of shapes or forms beyond that shown in FIG. 1, and can include walls, dividers and/or platforms in various configurations, and/or can include skids, rollers or the like configured to support thereon boats, watercraft, snow mobiles etc.

The trailer 12 can includes at least one trailer wheel 22 and typically would have a pair of opposed, aligned trailer wheels 22 (only one of which is shown in FIG. 1) coupled to the frame 14. The trailer 12 can also include a trailer coupling or trailer hitch coupling 24 at a forward end thereof. The trailer coupling 24 is configured to be releasably coupled to a trailer hitch of a self-powered vehicle, such as a car, truck, tractor or the like, to thereby couple the trailer 12 to the self-powered vehicle.

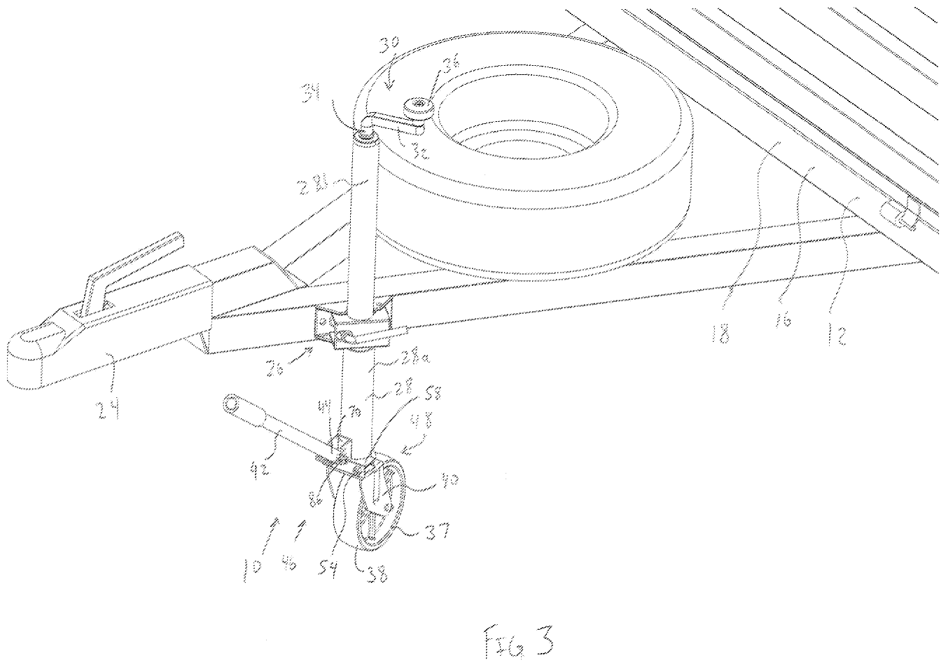

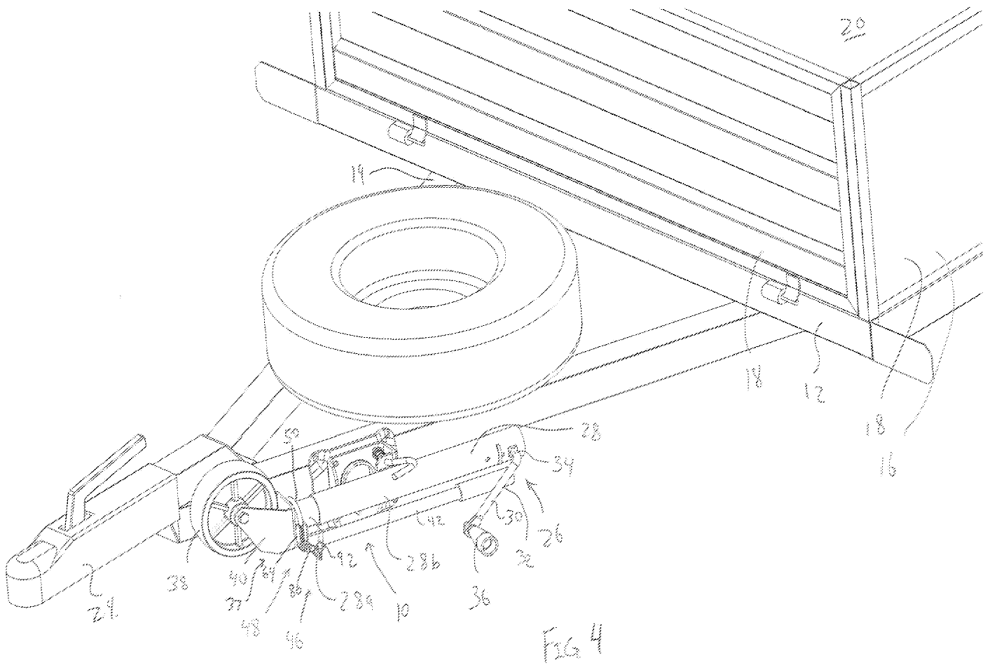

The trailer 12 and/or steering device 10 can include a trailer jack 26 coupled to the frame 14. The trailer jack 26 can include a jackshaft or shaft 28 or that includes, in one embodiment, a lower shaft portion 28a and an upper shaft portion 28b that is telescopingly receivable in the lower shaft portion 28a. In the embodiments of FIGS. 1-3, the lower shaft portion 28a is larger than the upper shaft portion 28b such that the upper shaft portion 28b can be entirely or mostly received in the lower shaft portion 28a. However this configuration can be reversed as shown in FIG. 4 where the upper shaft portion 28b is larger and can entirely or mostly receive the lower shaft portion 28a therein. The shaft 28 is generally cylindrical (having a generally circular cross-sectional shape) in the illustrated embodiment, although the shaft 28 can have various other shapes/cross-sections as desired. A hand crank 30 is operatively coupled to at least one of the shaft portions 28a, 28b such that upon manual rotation of the crank 30 the telescoping portions 28a, 28b move either away from each other or into each other in a telescoping manner, to thereby adjust the effective length of the shaft 28/trailer jack 26. For example, FIGS. 1-3 illustrate the trailer jack 26 in a relatively long/expanded position in which the shaft portions 28a, 28b are generally not nested or positioned inside each other. FIG. 4 shows the trailer jack 26 in a relatively short/compressed position in which the lower shaft portion 28a is generally received within the upper shaft portion 28b.

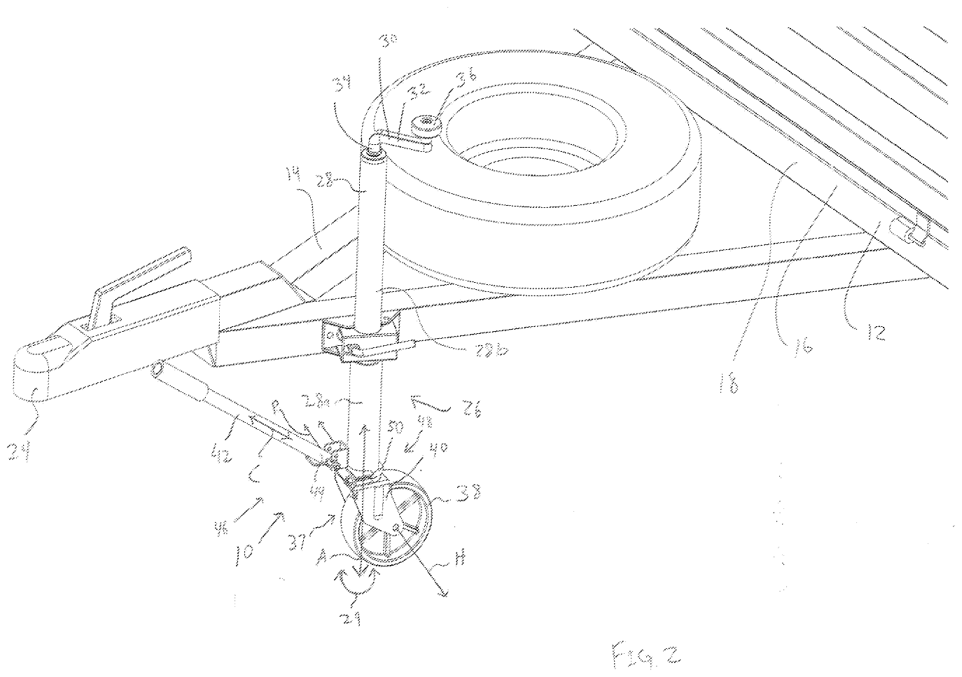

The crank 30 can have a generally “L” shape in one case, with a central portion 32 and arm 34 oriented generally perpendicular to the central straight portion 32 and positioned at one end thereof. A rotatable hand grip 36 is coupled to the central straight portion 32 at an opposite end thereof. This shape enables the crank 30 (or at least the arm 34) to be rotated about an axis oriented parallel to a central axis A (FIG. 2) of the shaft 28/trailer jack 26. However it should be understood that the effective length of the trailer jack 26 can be adjusted by methods/structure other than telescoping inner and outer shafts, side as side-by-side shaft portions, folding or accordion-style components, etc. In addition, in one case the shaft 28/trailer jack 26 is not necessarily expandable/retractable to adjust its effective length.

The trailer jack 26, in one embodiment, can be movable (pivotable in one case) between an operating position (as shown in FIGS. 1-3) and a retracted position (shown in FIG. 4). When in the operating position, the trailer jack 26 and shaft 28 (and the axis A) are generally aligned along/oriented with a vertical axis (with respect to a gravitational frame of reference). In contrast, when in the retracted position, the trailer jack 26 and shaft 28 (and axis A) are oriented in a generally horizontal direction/axis in the illustrated embodiment. The trailer jack 26 can be positioned in the reacted position when not in use, and in particular when the trailer 12 is to be transported over roads or the like to ensure the trailer jack 26 is positioned out of the way, or when the trailer 12 is stored. However, in some cases the trailer jack 26 is not necessarily movable between the operating and retracted positions and may, for example, be able to be contracted to a short/compressed position where the trailer jack 26 has sufficient clearance with an underlying ground or road surface.

The trailer jack 26 can include a foot 37 in the form of a trailer jack wheel 38 in one case coupled to the shaft 28, and more particularly the lower shaft portion 28a in the illustrated embodiment. The trailer jack wheel 38 is rollable/rotatable about a horizontal axis H (FIG. 2) when the trailer jack 26 is in its operating position. The trailer jack wheel 38 may also include/be coupled to a rotatable caster 40 which is, in turn, coupled to the trailer jack 26/shaft 28 such that the trailer jack wheel 38 is rotatable or pivotable about the central axis A (which is a vertical axis when the trailer jack 26 is in its operating position) as shown by arrow 29.

In order to utilize the trailer jack 26, the trailer jack 26 may begin in its retracted position shown in FIG. 4, such as when the trailer 12 is in storage. In addition, when in this configuration the trailer jack 26 can be in the relatively short/compressed position in which one of the lower shaft portion 28a or upper shaft portion 28b is positioned inside the other one of the lower shaft portion 28a or upper shaft portion 28b. Next, the trailer jack 26 is moved/pivoted to its vertical/operating position, and the hand crank 30 is operated to extend/expand the trailer jack 26 along the vertical direction until the trailer jack wheel 38 engages the horizontal ground surface and bears some weight of the trailer 12, as shown in FIGS. 1-3. In some cases however it should be understood that the trailer jack 26 does not include a trailer jack wheel 38, and the foot 37 instead takes the form of a platform, support surface, or simply a lower surface of the shaft 28/lower shaft portion 28a.

When the trailer jack 26/trailer jack wheel 38 engages the ground surface, the trailer jack wheel 38 thereby provides an additional point of contact between the trailer 12 and the ground surface to provide stability to the trailer 12 such that it can be maneuvered about the three wheels 22, 38. The trailer 12 can then be manually moved (or in one case, moved by a motor or other motive source) to align the trailer coupling 24 with the trailer hitch of a powered vehicle. In some cases, however, the trailer jack wheel 38 may need to be pivoted or rotated to a desired position in order to enable the trailer 12 to be moved into the desired direction. In the case where the trailer jack 26/foot 37 lacks a trailer jack wheel 38, a user may simply need to lift the trailer 12 such that the trailer jack 26/foot 37 is not bearing any weight, and then move or manipulate the trailer 12 (e.g. about the wheel(s) 22).

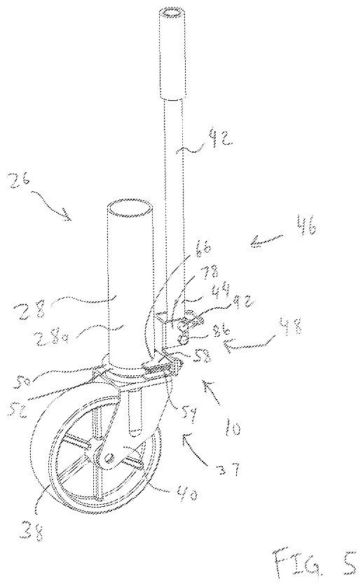

In order to aid in manipulation of the trailer jack 26/trailer jack wheel 38, the steering device 10, in the form of or including a handle 42 in one case, can be coupled to the trailer jack 26. In the illustrated embodiment the handle 42 takes the form of a generally cylindrical component that is pivotably coupled to the trailer jack 26. In the illustrated embodiment the handle 42 is pivotable about a pivot axis P (FIG. 2) that extends generally parallel to the ground surface and/or to the axis H about which the trailer jack wheel 38 is rollable. The handle 42 can thus be positioned in a retracted position (FIGS. 4 and 5) wherein the handle 42 is oriented generally parallel to the shaft 28 and adjacent to the shaft 28 (along an entire length of the handle 42) and/or is oriented generally vertically (when the trailer jack 26 is in an operating position). The handle 42 is movable/pivotable about the pivot axis P to an engaged position (FIGS. 1-3) wherein the handle 42 is oriented at an angle relative to the shaft 28 and/or positioned at least partially spaced away from the shaft 28 and/or oriented at an angle relative to the vertical axis (when the trailer jack 26 is in the operating position).

In the illustrated embodiment, when the handle 42 is in the engaged position the handle 42 forms an angle of about forty five degrees relative to vertical and/or the shaft 28 and/or the ground surface. However the handle 42 can be movable/pivotable to any of a wide variety of angles when in the engaged position, such as at least about twenty degrees in one case or at least about thirty degrees in another case, and at least about ninety degrees in yet another case (in which case the handle 42 may be pivotable to a generally horizontal configuration when the trailer jack 26 is in its operating position), or greater than ninety degrees in one case. In one case the handle 42 may be freely pivotable about its entire range of motion without any stops or detents. In another case, stops or detents may be provided at certain locations (e.g. when the handle 42 is at a ninety degree angle and/or forty-five degree angle relative to the shaft 28) to provide a hard stop or resistance to further pivoting of the handle 42. The handle 42 may be able to be secured in place, and blocked from rotation/pivoting or movement between the retracted and engaged position, when in both the retracted and engaged positions as will be described in greater detail below.

The handle 42 can be used to manipulate, move and/or guide the trailer jack wheel 38/trailer jack 26/frame 14. In particular, as can be seen in FIGS. 1-3, the handle 42, when in the engaged position, is configured and positioned to be gripped and moved by a user/operator to move the trailer jack wheel 38. In one embodiment the handle 42 can be used to rotate or pivot the trailer jack wheel 38 about the vertical axis (when the trailer jack 26 is in the operating position)/axis A of the shaft 28 where the lower shaft portion 28a rotates relative to the upper shaft portion 28b in one case. In particular, because the handle 42 extends outwardly from the axis A of the shaft 28/trailer jack wheel 38, the handle 42 operates as a lever arm to provide significantly increased leverage to the operator/user, thereby allowing the operator/user to easily pivot the trailer jack wheel 38 in the direction of arrow 29 of FIG. 2. In addition, because the handle 42 extends away from the trailer jack wheel 38, the handle 42 provides a convenient gripping component such that, for example, the user/operator is not required to bend to ground level and/or reach entirely under the frame 14. The handle 42 may also be able to be conveniently used to pull/push the trailer 12 into the desired position (e.g. move the entire trailer 12 by causing rolling of the trailer wheels 22, rather than simply rotating/pivoting the trailer jack wheel 38; or to lift and move the trailer 12 when the foot 37 lacks a trailer jack wheel 38).

In one case, the handle 42 is a generally longitudinally extending body and has a length at least about six inches in one case (at least about ten inches in another case, and is about sixteen inches long in one case). In another embodiment the handle 42 has a length at least double the diameter of the trailer jack wheel 38. By providing a sufficient length to the handle 42, the handle 42 can be relatively easily gripped and provide sufficient leverage to move/pivot the trailer jack wheel 38/trailer 12. In addition, in one embodiment the handle 42 can be positioned along a lower portion of the trailer jack 26/shaft 28, such as in a lower 25 percent thereof in one case or a lower 10 percent thereof in another case, or a bottom/lower half thereof, so that the handle 42 does not contact the frame 14 when the handle 42 is moved to its engaged position.

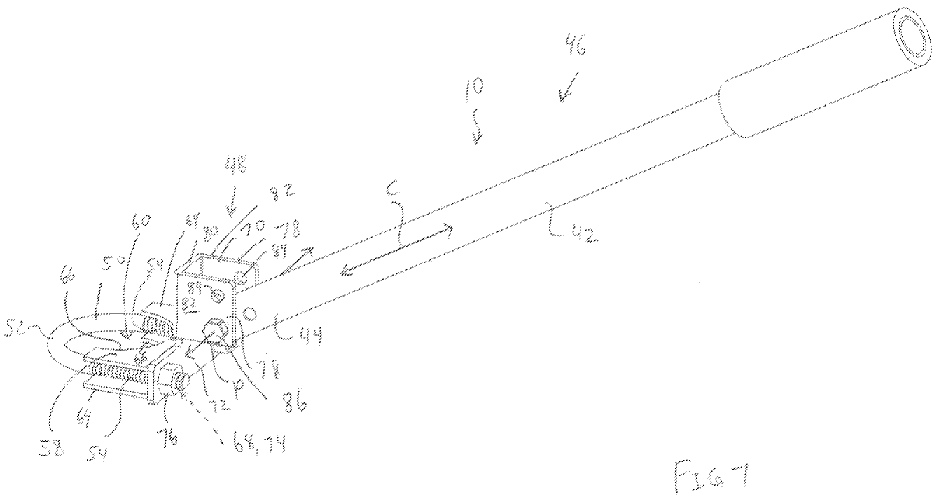

In one case, the handle 42 is generally straight along its entire length and has a central axis C (FIGS. 2 and 7). This is in contrast with, for example, the crank 30 as outlined above which can have “L” shape or a zig-zag shape. However if desired the handle 42 can have shapes other than straight. For example the handle 42 can have a distal grip portion that is oriented at a ninety degree angle relative to the remainder of the handle 42, or oriented perpendicular to an axis about which the wheels 22 rotate, to act analogous to a “wagon handle” wherein the grip portion is oriented parallel to the forward or pulling direction; or have a bend or a triangle at an end thereof which can act as a gripping surface to aid a user in pulling and steering at the same time. In addition, the handle 42 can include a base portion 44 at a base end thereof/positioned immediately adjacent to the shaft 28 (e.g. in one case the portion of the handle 42 located closest to the shaft 28/trailer jack 26 and/or at an end of the handle 42 and/or directly connected to the shaft 28/trailer jack 26), and the handle 42/base portion 44 is pivotable about the pivot axis P that is oriented perpendicular to a central axis C of the handle 42/base portion 44. The handle 42 may also not be operable to adjust the effective length of the shaft 28/trailer jack 26; e.g. the handle is not operatively coupled to any device or mechanism that moves the lower 28a and/or upper 28b shaft portions relative to each other. In one case, the handle 42 is not rotatable about its central axis C.

In one embodiment, the steering device 10/handle 42 can be coupled to the trailer jack 26 and trailer 12, and sold as an integrated unit with the trailer 12/trailer jack 26. In another embodiment, the steering device 10/handle 42 can be integrated with/coupled to the trailer jack 26 and sold together as a unit. In yet another embodiment the steering device 10/handle 42 can be sold as a handle assembly/kit/stand-alone unit 46 (shown in its assembled configuration in FIG. 7) and coupled to an existing trailer 12/trailer jack 26 as an aftermarket item.

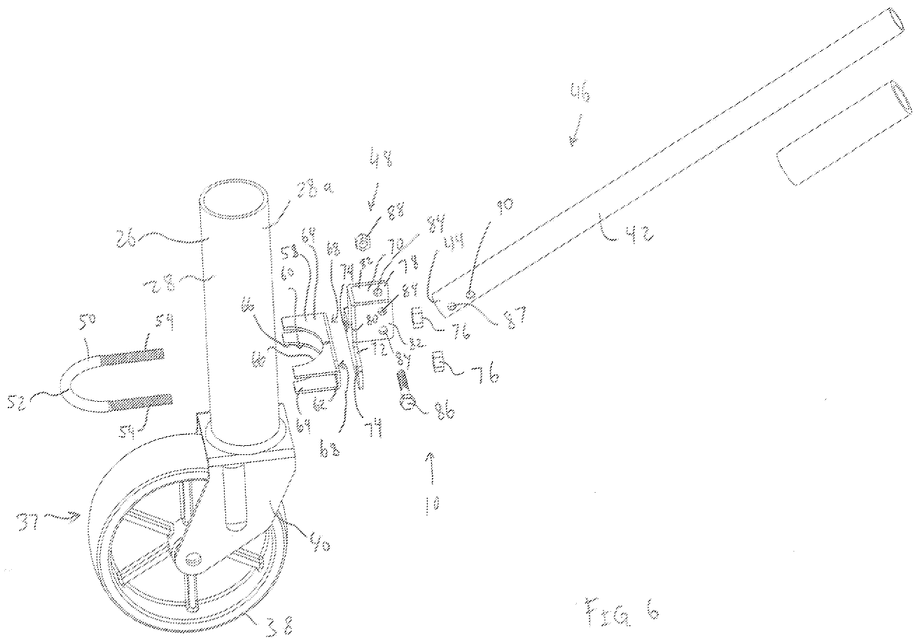

The handle assembly 46 can thus include the handle 42 and an attachment assembly 48 configured to couple the handle 42 to the shaft 28/trailer jack 26. The attachment assembly 48 can include, with reference to FIGS. 6 and 7, a generally U-shaped bolt 50 with a base portion 52 having a diameter that is, in one case, the same as or configured to relatively closely conform to a diameter of the shaft 28 (or other shape of the shaft 28, if the shaft 28 is other than cylindrical; for example a square tube). The U-shaped bolt 50 may include a pair of opposed, parallel threaded ends 54.

The attachment assembly 48 can further include a bracket 58 that is configured to receive the two ends 54 of the U-shaped bolt 50 therethrough to couple the U-shaped bolt 50 and bracket 58 together, with the shaft 28/trailer jack 26 trapped/positioned therebetween. In particular, the bracket 58 can include a recess 60 that matches or is configured to closely receive the shaft 28 therein (e.g. the recess 60 can have a diameter matching or generally corresponding to the diameter of the shaft 28 and in one case extends for about 180 degrees). The recess 60 can of course have other shapes (e.g. square in one case) to match the corresponding shape of the outer surface of the shaft 28. The bolt 50 can have other shapes to match the shape of the shaft 28, but can still be considered to be generally “U” shaped when the bolt 50 is configured to engage a square shaft 28, a hexagonal shaft 28, etc.

The bracket 58 can be generally “U” shaped in end view, having a base portion 62 and a pair of parallel legs 64 oriented generally perpendicular to the base portion 62. Each leg 64 has a curved portion 66 (or other shape/recess) which together define the recess 60. The base portion 62 includes a pair of spaced openings 68, where each opening 68 is shaped and positioned to receive a threaded end 54 of the U-shaped bolt 50 therethrough.

The attachment assembly 48 can further include an adapter 70 coupled to the bracket 58. The adapter 70 includes a base portion 72 including a pair of spaced openings 74 configured to be aligned with the openings 68 of the bracket 58, and to receive an two end 54 of the U-shaped bolt 50 therethrough. A pair of nuts 76 can then be threaded onto the ends 54 of the U-shaped bolt 50 as shown in FIG. 7, to thereby secure the U-shaped bolt 50, bracket 58 and adapter 70 together in the configuration shown. The nuts 76 should be sufficiently tightened to secure the U-shaped bolt 50 and bracket 58 in place and prevent pivoting thereof about the axis A, particularly when the trailer jack 26 has a cylindrical shape.

The adapter 70 can include a generally “U” shaped flange 78 including a base portion 80 and a pair of opposed, parallel legs 82, where leg 82 includes a pair of aligned openings 84. The handle 42 is configured to be received between the two legs 82 of the flange 78, with a threaded fastener 86 passed through the lower set of openings 84 and a lower opening 87 of the handle 42, to provide or define the pivot axis P of the handle 42, and is secured in place with a nut 88. If desired, the handle 42 can be pre-attached to the adapter 70 at the time of the shipping of the handle assembly 46 to the end user.

The handle 42 can include an upper opening 90 formed therethrough, which is configured to be aligned with the set of upper openings 84 of the flanges 78 when the handle 42 is in the retracted position. In this manner, a securing fastener 92 (see FIGS. 4 and 5), such as a locking pin, can be removably passed through the aligned openings 84, 90 when the handle 42 is in the retracted position to secure the handle 42 in the retracted position. Of course, if desired the handle 42/handle assembly 46 can be coupled to the trailer jack 26 by various other means or mechanisms, such as welding, passing fasteners through holes formed in the trailer jack 26, etc.

In this manner, the steering device 10/handle 42/handle assembly 46 can be sold, installed or implemented in a wide variety of manners, including as an aftermarket component. Once installed, the steering device 10/handle 42/handle assembly 46 provides ease of use to access the handle 42 and move the trailer 12/trailer jack wheel 38 to the desired orientation, and to provide the benefits relating to the manipulation of the trailer 12/trailer jack 26/trailer jack wheel 38 as described above.

In the illustrated embodiment, the handle 42 can be mounted to the trailer jack 26 such that the handle 42 points “forward” is generally aligned with the trailer jack wheel 38 (e.g. the central axis C of the handle 42 is generally perpendicular to the horizontal axis H of the trailer jack wheel 38 when in the configuration shown in FIG. 2). However the handle 42 can be mounted to the trailer jack 26 in various other configurations including in positions where the handle 42 is rotated 90 degrees (points “sideways) or 180 degrees (points “backward”), or other amounts of rotation, about the axis A from the position shown in FIG. 2. It should be further understood that the trailer jack 26 can have any of a wide variety of shapes, configurations and methods of use/operation, and the steering device 10/handle 42/handle assembly 46 can be used with all or nearly all embodiments of trailer jacks 26, so long as the steering device 10/handle 42/handle assembly 46 can be coupled to the trailer jack 26 and used in the desired manner.

Having described the invention in detail and by reference to the preferred embodiments, it will be apparent that modifications and variations thereof are possible without departing from the scope of the invention.

What is claimed is:

1. A trailer comprising:
a frame configured to receive an item or items to be stored thereon or therein;
at least one trailer wheel coupled to the frame; and
a trailer jack coupled to the frame and including a foot at an end thereof, wherein the trailer jack includes a handle coupled thereto, wherein the handle is pivotable between a retracted position wherein the handle is oriented generally vertically when the trailer jack is in the operating position, and an engaged position wherein the handle is oriented at an angle relative to a vertical axis when the trailer jack is in the operating position.

2. The trailer of claim 1 wherein the foot includes a trailer jack wheel that is rotatable or pivotable about the vertical axis when the trailer jack is in the operating position, and wherein the handle, when in the operating position, is manually operable to rotate or pivot the foot about the vertical axis when the trailer jack is in the operating position.

3. The trailer of claim 2 wherein the trailer jack includes a shaft that is aligned with the vertical axis when the trailer jack is in the operating position, wherein the trailer jack wheel is coupled to the shaft, and wherein the handle is aligned with and positioned immediately adjacent to the shaft when the handle is in the retracted position.

4. The trailer of claim 2 wherein the handle has a length that is at least about double a diameter of the trailer jack wheel.

5. The trailer of claim 1 wherein the handle is oriented at an angle of at least about twenty degrees relative to the vertical axis when the handle is in the engaged position and when the trailer jack is in the operating position.

6. The trailer of claim 1 wherein at least part of the trailer jack is movable or extendable along a length of the trailer jack to adjust an effective length of the trailer jack.

7. The trailer of claim 6 wherein the trailer jack includes a crank that is manually operable to adjust the effective length of the trailer jack.

8. The trailer of claim 1 wherein the trailer jack includes a shaft with two telescoping shaft portions, wherein the handle is securable in both the retracted position and the engaged position, and wherein the handle has a length of at least about eight inches.

9. The trailer of claim 1 wherein the handle is coupled to a bottom half of the trailer jack when the trailer jack is in the operating position.

10. The trailer of claim 1 wherein the handle is generally straight along its entire length.

11. The trailer of claim 1 wherein the trailer jack includes a shaft and wherein the handle has a base portion positioned immediately adjacent to the shaft, and wherein the base portion is pivotable about an axis oriented perpendicular to a central axis of the base portion when the handle pivots between the retracted position and the engaged position.

12. The trailer of claim 1 wherein the trailer jack is movable between the operating position wherein the trailer jack is oriented generally vertically and a retracted position wherein the trailer jack is oriented generally horizontally.

13. The trailer of claim 1 wherein the trailer jack includes a generally cylindrical shaft that is oriented generally vertically when the trailer jack in is in the operating position, and wherein the trailer jack further includes an attachment assembly configured to couple the handle to the shaft.

14. The trailer of claim 13 wherein the attachment assembly includes a generally U-shaped bolt and a bracket receiving two ends of the U-shaped bolt therethrough to couple the U-shaped bolt and the bracket together with the shaft positioned therebetween, wherein the bracket includes a curved recess configured to receive the shaft therein, wherein the attachment assembly further includes an adapter coupled to the bracket, and wherein the handle is pivotally coupled to the adapter.

15. A method for securing a handle to a trailer comprising:
accessing a trailer including a frame configured to receive an item or items to be stored thereon or therein, at least one trailer wheel coupled to the frame, and a trailer jack coupled to the frame and including a foot at an end thereof; and
securing a handle to the trailer jack, wherein after the securing step the handle is pivotable between a retracted position wherein the handle is oriented generally vertically when the trailer jack in in the operating position, and an engaged position wherein the handle is oriented at an angle relative to the vertical axis when the trailer jack is in the operating position.

16. The method of claim 15 wherein the foot includes a trailer jack wheel that is rotatable or pivotable about a vertical axis when the trailer jack is in the operating position, and wherein the method further comprises manually manipulating the handle to rotate or pivot the trailer jack wheel about the vertical axis.

17. A handle assembly comprising:
an attachment assembly including a generally U-shaped bolt, a bracket configured to receive two ends of the U-shaped bolt therethrough to couple the U-shaped bolt and the bracket together with a shaft therebetween, wherein the bracket includes a recess configured to closely receive the shaft therein, and wherein the attachment assembly includes an adapter configured to be coupled to the bracket; and
a handle configured to be pivotally coupled to the adapter.

18. The assembly of claim 17 wherein the bracket is generally “U” shaped in end view and has a base portion and a pair of legs, each leg having a curved portion defining the recess, the base portion including a pair of spaced openings, each opening being configured to receive an end of the U-shaped bolt therethrough, each end of the U-shaped bolt being threaded, wherein the adapter includes a pair of openings configured to be aligned with the openings of the bracket and to receive an end of the U-shaped bolt therethrough, the adapter including a generally U-shaped flange configured to receive the handle therein, and wherein the handle is a generally longitudinally extending body.

19. A trailer jack assembly comprising:
a shaft defining an axis;
a foot coupled to an end of the shaft or forming an end of the shaft; and
a handle coupled to the shaft, wherein the handle is pivotable between a retracted position wherein the handle is oriented generally parallel to the axis and an engaged position wherein the handle is oriented at an angle relative to the axis.

20. The trailer jack of claim 19 wherein the foot includes a trailer jack wheel that is rotatable or pivotable about the axis, wherein the trailer jack is configured to be coupled to a trailer, wherein the trailer jack includes a crank that is manually operable to adjust an effective length of the trailer jack, and wherein the angle is at least about twenty degrees.
